(19) United States
(12) Patent Application Publication
(10) Pub. No.: US 2001/0006502 A1
(43) Pub. Date: Jul. 5, 2001

(54) Disk recording method and apparatus providing for realtime monitoring

(75) Inventors: Hiroshi Tsuyuguchi, Tokyo (JP); Sho Sugiyama, Hannou-shi (JP)

Correspondence Address: WOODCOCK WASHBURN KURTZ, MACKIEWICZ & NORRIS LLP, One Liberty Place - 46th Floor, Philadelphia, PA, 19103, US

(73) Assignee: TEAC Corporation

(21) Appl. No.: 09/737,305

(22) Filed: Dec. 15, 2000

(30) Foreign Application Priority Data
Dec. 28, 1999 (JP) 11-373183

(51) Int. Cl. G11B 7/0045

(52) U.S. Cl. 369/53.36; 369/53.37; 369/47.3; 369/59.14

(57) ABSTRACT

A CD-R recorder capable of recording a digitized audio signal or the like on a CD-R so as to permit realtime monitoring of the recording. Successive segments of the digitized input signal are stored, one at a time, on an input buffer memory, from which each signal segment is read out in time compression mode and recorded on the CD-R. The successive signal segments are therefore recorded at prescribed time intervals. Each recorded signal segment on the disk is then immediately recovered there-from during the time interval between the end of recording of this segment and the beginning of that of the next segment. After being stored on an output buffer memory, the recovered signal segment is immediately read out therefrom in time extension mode, such that the successive segments of the digital signal are read out as a streamlined continuum, an exact replica of the input signal, to enable realtime monitoring of the recording being made on the disk. The recovered signal may be reconverted into an analog equivalent before being put out.

### BACKGROUND OF THE INVENTION

This invention relates to the recording of information, audio or otherwise, on and from a rotating data storage disk such as, typically, a recordable compact disk (CD-R). More specifically, the invention deals with a disk recorder, as typified by a CD-R recorder, including provisions for concurrent monitoring of the recording being executed on the disk.

CD-Rs with associated CD-R recorders are winning ever-increasing acceptance among, in particular, audiophiles, as well as specialists, experts, and enthusiasts in other fields Among the advantages of CD-Rs are: (a) compatibility with CDs and CD-ROMs, recorded CD-Rs being reproducible on any audio CD players or CD-ROM drives; (b) large recording capacity (650 MB); and (c) low cost per unit of information recordable (hard magnetic disks are ten times as expensive per MB, and flexible magnetic disks, several tens of times). However, CD-Rs are unlike magnetic disks or magnetic tape in that they are recordable once for all. A failure in recording is irrecoverable, no rerecording being possible, so that the disk has to be discarded in chap event.

Despite the once-for-all recording capability of CD-Rs, the CD-R recorders as so far manufactured and introduced to the market have not, as far as the instant applicant is aware, been equipped for monitoring of the recording In progress. The user has therefore had to wait for the completion of the recording to know whether his or her source has been recorded properly. In the worst case, therefore, he or she has realized that he or she has failed, and so thoroughly wasted his or her time, after a very long recording session, as in the recording of classical music.

An obvious remedy to this shortcoming might seem a two-beam monitoring method, such that the transducer simultaneously emits both write beam and read beam onto the disk so that the information being recorded may be reproduced substantially concurrently. This method would render the CD-R recorder inordinately complex and expensive in construction, not likely to be accepted by consumers in general.

### SUMMARY OF THE INVENTION

The present invention seeks to enable realtime monitoring of the recording being made on a CD-R or like rotating data storage disk, in a simple, inexpensive, and thoroughly practicable way.

Also, in attaining the first recited objective, the present invention seeks to record desired information on a CD-R or the like in such a way that the recorded disk is reproducible on any commercial CD-R player, CD-ROM drive, or other rotating disk data storage apparatus.

Briefly stated in one aspect thereof, the invention concerns a method of recording a digital audio or like signal on a rotating data storage disk in a manner enabling realtime monitoring of the recording on the disk. Successive prescribed segments of a digital signal to be recorded are first stored, at least one at a time, on an input buffer memory, from which each signal segment is read out in time compression mode and recorded on a rotating data storage disk. The successive signal segments are thus recorded at prescribed time intervals. Each signal segment recorded or, the disk is recovered therefrom during the time interval between the recording of this segment and that of the next and stored on an output buffer memory. From this memory, then, the signal segment is read out in time extension mode.

Thus the successive segments of the digital signal can be read out from the output buffer memory as a streamlined continuum, concurrently with the progress of the recording of that signal. The continuously recovered digital signal may be translated into an analog signal for monitoring.

According to another feature of the invention, the data storage disk is maintained throughout the recording operation in rotation at a constant linear velocity that is predetermined in relation to the extent to which each signal segment is time compressed when being read out from the input buffer memory. Consequently, the signal segments can be recorded on the disk without intervening blanks, thereby permitting the disk to be played or read on any commercial device designed for use therewith.

Another aspect of the invention concerns a disk recording apparatus for carrying the above summarized method into practice. The apparatus can be constructed from largely conventional, expensive parts and components only, including the familiar transducer that uses but one beam for both writing and reading. The recording method according to the invention may be factory preprogrammed into the controller that is normally found in a CD-R recorder or the like.

The above and other objects, features and advantages of the invention and the manner of realizing them will become more apparent, and the invention itself will best be understood, from the following description taken together with the attached drawings showing the preferred embodiments of the invention.

### BRIEF DESCRIPTION OF THE DRAWINGS

FIG. 1 is a block diagram of the CD-R recorder embodying the principles of the present invention;

FIG. 2 is a block diagram of the transducer assembly of the FIG. 1 recorder;

FIG. 3 is a graph explanatory of the intensity of the laser beam emitted by the FIG. 2 transducer assembly in write mode and read mode;

FIG. 4 is a block diagram equivalently depicting the controller of the FIG. 1 recorder;

FIG. 5, consisting of (A) through (F), is a timing diagram explanatory of how a digitized audio or like input signal is recorded on the CD-R in the FIG. 1 recorder, and the recording concurrently monitored, according to the invention; and

FIGS. 6A, 6B and 6C show in combination a flowchart of the recording program introduced into the controller of the FIG. 1 recorder.

### DESCRIPTION OF THE PREFERRED EMBODIMENT

The present invention will now be described as embodied in a CD-R recorder for use with interchangeable CD-Rs. As has been standardized in the art, an unused CD-R has a preformed groove, or pregroove, cut in its surface in the form of a multiturn spiral, along which the beam of light is to be guided for writing. Irradiating the pregroove, the light beam conventionally provides a tracking error signal which is used for tracking control, that is, for keeping the beam spot centered on the track. The pregroove slightly “wobbles” in a regular zigzag fashion, as is also conventional in the art, such that when the beam scans it at a prescribed linear velocity for writing, the tracking error signal includes a wobble component with a standard frequency of 22.05 kHz.

The tracking error signal with the wobble component serves some important known purposes En addition to tracking control. One of them is disk speed control. The disk speed is servo controlled to maintain the wobble signal at 22.05 kHz. Another purpose is the provision of the positional information of the beam spot on the disk. The wobble frequency on the disk is frequency modulated at 22.05 kHz±1 kHz to include track address information known as ATIP (absolute time in the pregroove). This address information is therefore derivable from the wobble component of the tracking error signal.

As is also well known in the art, recording on CD-Rs is done under the control of write pulses. User data is written during the durations of the write pulses, and the wobbling pregroove is read during the pulse spacings to provide the tracking error signal with the wobble component. Writing is alternate, or almost concurrent, with reading. The light beam tracing the pregroove is alternately switched between write intensity and read intensity with the progress of alternate writing and reading. The required tracking information and address information are gained during such intermittent reading.

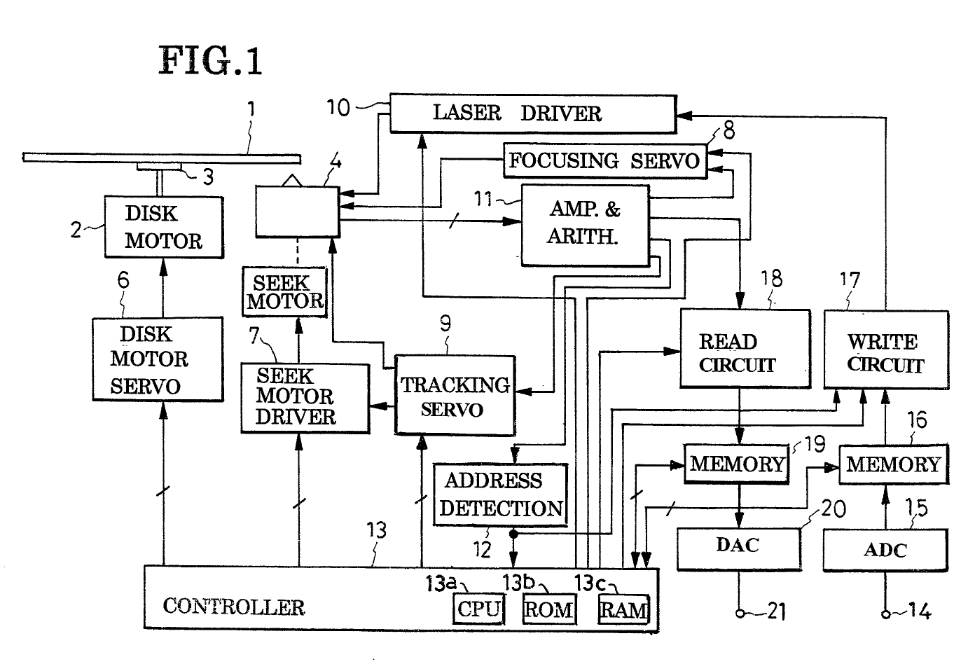

An example of CD-R recorder embodying the principles of this invention is illustrated in FIG. 1 and therein shown together with a CD-R 1. The exemplified CD-R recorder comprises:

(1) A disk motor 2 for directly driving a turntable 3 on which the CD-R 1 is mounted for recording.

(2) An optical read/write head or transducer assembly 4 for emitting a beam of light, usually a laser beam, for optically reading and writing data on the CD-R 1.

(3) A seek motor 5 coupled to the transducer assembly 4 for positioning the same on any track position on the CD-R 1.

(4) A disk motor servo circuit 6 for driving the disk motor 2 under servo control of the motor speed.

(5) A seek motor driver circuit 7 for controllably driving the seek motor 5.

(6) A focusing servo circuit 8 electrically connected to the transducer assembly 4 for keeping the light beam focused on the pregrooved surface of the CD-R 1.

(7) A tracking servo circuit 9 also connected to the transducer assembly 4 for keeping the light beam aligned on the pregroove or data track on the CD-R 1.

(8) A laser driver circuit 10 also connected to the transducer assembly 4 for causing the same to emit the light beam of controlled intensities.

(9) An amplifying and arithmetic circuit 11 also connected to the transducer assembly 4 for amplifying and further arithmetically processing the electric output therefrom.

(10) An address detection circuit 12 for detecting track addresses from the output from the amplifying and arithmetic circuit 11.

(11) A factory-preprogrammed controller 13 for supervising and controlling the operation of the complete CD-R recorder, particularly the recording operation with realtime monitoring according to the present invention.

(12) An analog-to-digital converter (ADC) 15 connected to an input terminal 14 for digitizing an analog input signal, such as audio signal, to be recorded.

(13) An input buffer memory 16 for inputting each of successive prescribed segments of the digitized input signal and putting each segment out in timecompression mode, such that time intervals are inserted between the signal segments.

(14) A write circuit 17 connected between input buffer memory 16 and laser driver circuit 10 for causing the transducer assembly 4 to record the input signal on the CD-R 1.

(15) A read circuit 18 for processing the output from the amplifying and arithmetic circuit 11 into a read data signal of more well defined waveform.

(16) An output buffer memory 19 for inputting the read data signal, still in the form of time-compressed, spaced segments, and putting the same out in time extension mode, such that the signal segments are recombined into a streamlined continuum.

(17) A digital-to-analog converter (DAC) 20 connected between the output buffer memory 19 and an output terminal 21.

Replaceably mounted on the turntable 3, the CD-R 1 is driven directly by the disk motor 2. The disk 1 has its pregrooved surface shown directed downwardly in this figure, facing the transducer assembly 4 which is to be driven by the seek motor 5 across the spiraling pregroove on the disk. The disk motor 2 is capable of driving the disk 1 not only at the standard speed common to CDs and CD-Rs, and at a prescribed speed that is several times, or even several tens of times, as high as the standard speed, under the control of the disk motor servo circuit 6. The higher disk speed is needed for recording on the disk 1 with concurrent monitoring according to the invention, as will be detailed subsequently.

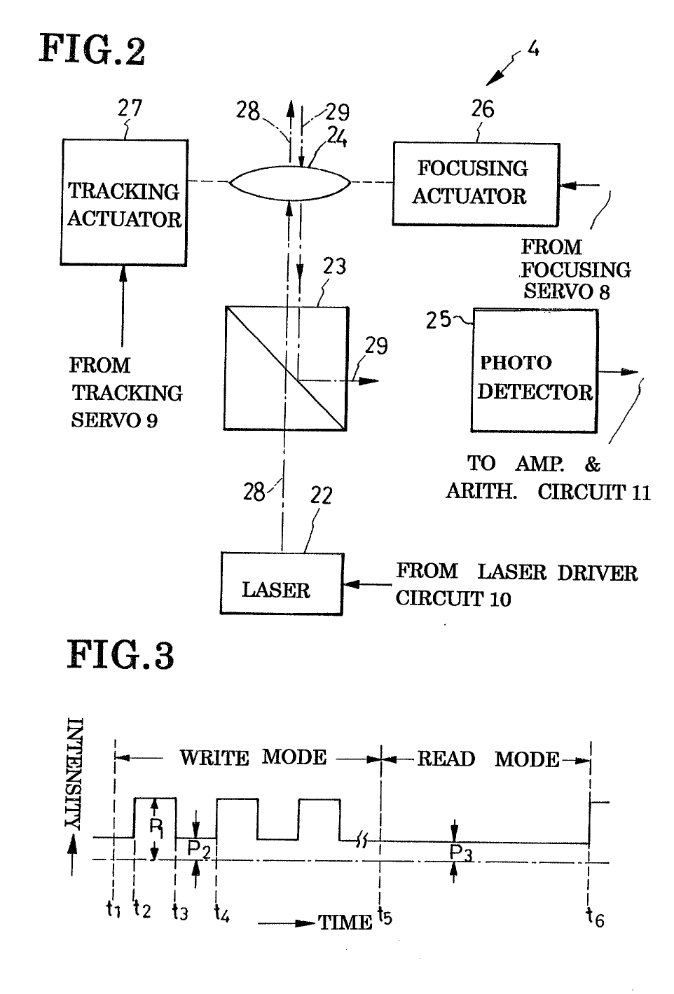

As illustrated in detail in FIG. 2, the transducer assembly 4 includes a light source shown as a laser 22 for emitting a beam of light 28 to be applied to the disk surface via an objective lens 24. A beam splitter 23 is positioned between the laser 22 and the objective 23 for passing the beam 28 from the laser 22 and reflecting the beam reflection 29 from the disk surface toward a photodetector 25, which translates the beam reflection into electric signals. The transducer assembly 4 further comprises a focusing actuator 26 such as a moving coil mechanically coupled to the objective 24 for keeping the laser beam 28 focused on the disk surface, and a tracking actuator 27, usually another moving coil, also coupled to the objective for keeping the laser beam centered on the track on the disk.

The laser 22 is conventionally controlled to emit a beam of different intensities depending upon whether it is creating a pit in the disk surface or not. As indicated in FIG. 3, the laser beam has two different intensities P₁ and P₂ in write mode lasting from t₁ to t₅, being of first intensity P₁ when creating a pit as from t₂ to t₃, and of second intensity P₂, less than the first P₁, when not creating a pit as from t₃ to t₄. In read mode lasting from t₅ to t₆, on the other hand, the beam is of third intensity P₃, also less than the first P₁, possibly equal to the second P₂. The periods of the second beam intensity P₂ during writing have been conventionally utilized solely for reading the wobbling pregroove for tracking control and address detection, but lend themselves to use for realtime monitoring of the recording according to this invention. The laser beam intensity is controlled as in FIG. 3 by the laser 6 driver circuit 10, FIG. 1.

With reference back to FIG. 1 the transducer assembly 4 is driven by the seek motor 5 under the control of the seek motor driver circuit 7. To this driver circuit 7 there are supplied both seek data from the controller 13 and a seek control signal from the tracking servo circuit 9, enabling the driver circuit to control the seek motor 5 accordingly.

The photodetector 25, FIG. 2, of the transducer assembly 4 is conventionally constituted of a set of photodiodes, not shown, for converting the incident laser beam, reflected back from the disk surface, into electric signals. Connected to the photodetector 25, the amplifying and arithmetic circuit 11 comprises amplifiers, adders and subtracters for conventionally processing the photodetector output signals into a read data signal indicative of data that has been read from the disk 1, a focusing error signal indicative of the degree of beam defocusing on the disk, and a tracking error signal indicative of the degree of departure of the beam spot from the track. The read data signal is applied to the read circuit 18, the focusing error signal to the focusing servo circuit 8, and the tracking error signal to the tracking servo circuit 9.

Also of prior art design, the read circuit 18 comprises a wave-shaping circuit, a phase-locked-loop circuit, an eight-to-fourteen-modulation (EFM) decoder, an error detection and correction circuit, etc. Processing the incoming read data signal by all these circuit means, the read circuit 18 puts out binary read data representative of the information recovered from the disk 1, for delivery to the output buffer memory 19.

Inputting the noted focusing error signal from the amplifying and arithmetic circuit 11, the focusing servo circuit 8 puts out a signal for driving the moving-coil focusing actuator 26, FIG. 2, of the transducer assembly 4. The focusing actuator 26 when so driven causes the objective 24 to move toward and away from the disk surface in order to keep the beam 28 focused on the disk surface. The controller 13 is connected to the focusing servo circuit 8 for on-off control of the focusing servo and for switching control of the phase compensation characteristic.

The tracking servo circuit 9 responds to the tracking error signal from the amplifying and arithmetic circuit 11 by producing a signal for driving the tracking actuator 27, FIG. 2, of the transducer assembly 4. So driven, the tracking actuator 27 causes the objective 24 to travel back and forth parallel to the disk surface in order to keep the beam spot in centerline alignment with the wobbling pregroove on the disk surface.

The controller 13 is connected to the tacking servo circuit 9, too, for on-off control of the tracking servo, for switching control of the phase compensation characteristic, and for jumping control of the laser beam. The jumping control is such that, in response to jumping pulses from the controller 13, the tracking servo circuit 9 causes the tracking actuator 27 to move the objective radially of the disk, with the consequent jumping of the laser beam 28 from one track turn to another on the disk. Thus the tracking servo circuit 9 and the tracking actuator 27 act in combination as beam positioning means, as do the seek motor driver circuit 7 and the seek motor 5.

Also having an input connected to the amplifying and arithmetic circuit 11, the address detection circuit 12 detects track addresses by demodulating the wobble component of the output from the circuit 11 during writing and, during reading, by demodulating the subcode component. The addresses detected are delivered to the controller 13 and, during writing, to the write circuit 17 as well.

The write circuit 17 has an input connected to the analog input terminal 14 via the ADC 15 and the input buffer memory 16, and an output connected to the laser driver circuit 10. Received at the input terminal 14, the analog audio or like signal to be recorded is digitized by the ADC 15, and the digital output therefrom directed into the buffer memory 16. Under the direction of the controller 13, then, the digital input signal is read out from the memory 16 in successive, isolated segments in time compression mode, with intervals between the signal segments, for delivery to the write circuit 17.

The write circuit 17 is itself of known construction comprising an encoder for eight-to-fourteen modulation of the input digital data, error correction means, and means for adding address data to the user data as subcode.

Write pulses representative of the digital data to be recorded are fed from write circuit 17 to laser driver circuit 10, which latter circuit responds by controlling the laser beam intensity accordingly. The controller 13 is also connected to the laser driver circuit 10 to notify the same of whether the recorder is in write mode or read mode. There exists a transitional interval from write mode to read mode in this embodiment of the invention, during which Interval the laser beam is to be held at the lower intensity P₂ or P₃ for address reading and tracking control purposes.

The read circuit 18 has an input connected as aforesaid to the amplifying and arithmetic circuit 11, and an output connected to the analog output terminal 21 via the output buffer memory 19 and DAC 20. The output buffer memory 19 inputs from the read circuit 18 the read data signal in the form of spaced, time-compressed segments and puts out the data segments in time extension mode.

The DAC 21 delivers an analog equivalent of the digital output from the buffer memory 19 to the output terminal 21. A headphone or a loudspeaker system, both not shown, are to be connected to the output terminal 21 for monitoring.

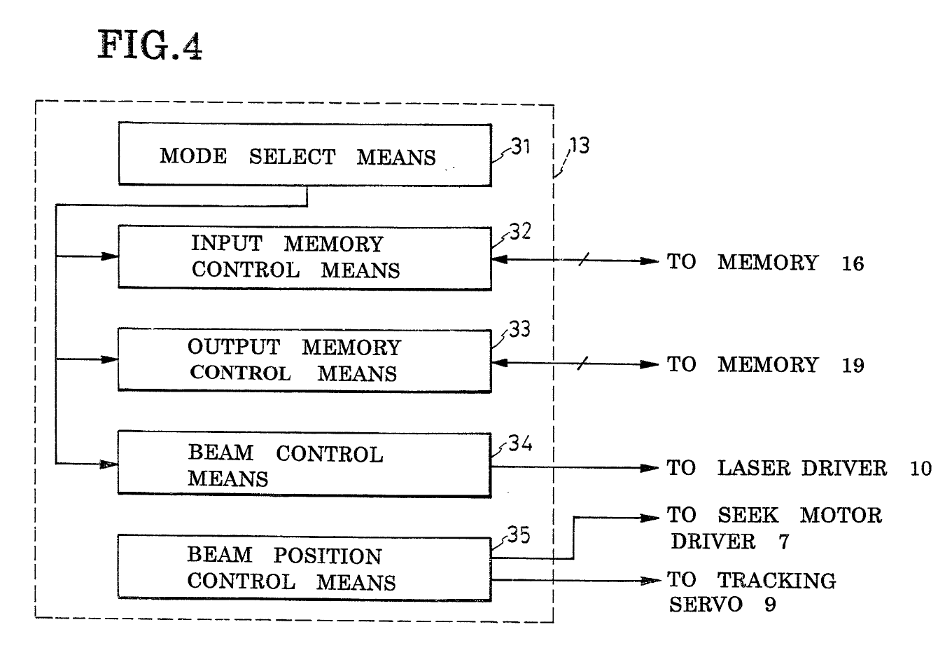

The controller 13 takes the form of a large-scale-integrated microprocessor or microcomputer including a central processor unit (CPU) 13a, a read-only memory 13b, and a random-access memory 13c. As illustrated block-diagrammatically in FIG. 4, the controller 13 may be considered to equivalently comprise, for the purposes of this invention:

(1) mode select means 31 for switching between write mode and read mode;

(2) input memory control means 32 for controlling the input buffer memory 16;

(3) output memory control means 33 for controlling the output buffer memory 19;

(4) beam intensity control means 34 for controlling the intensity of the laser beam 28; and

(5) beam position control means 35 for controlling the position of the beam spot on the disk 1.

The mode select means 31 are shown connected to the means 32-34 for supplying thereto a signal indicative of write or read mode. As is conventional in the art, the controller 13 additionally comprises means for controlling the disk motor 2, means for controlling the focusing servo, etc. Such known additional means are not shown because of their irrelevance to the instant invention.

Operation

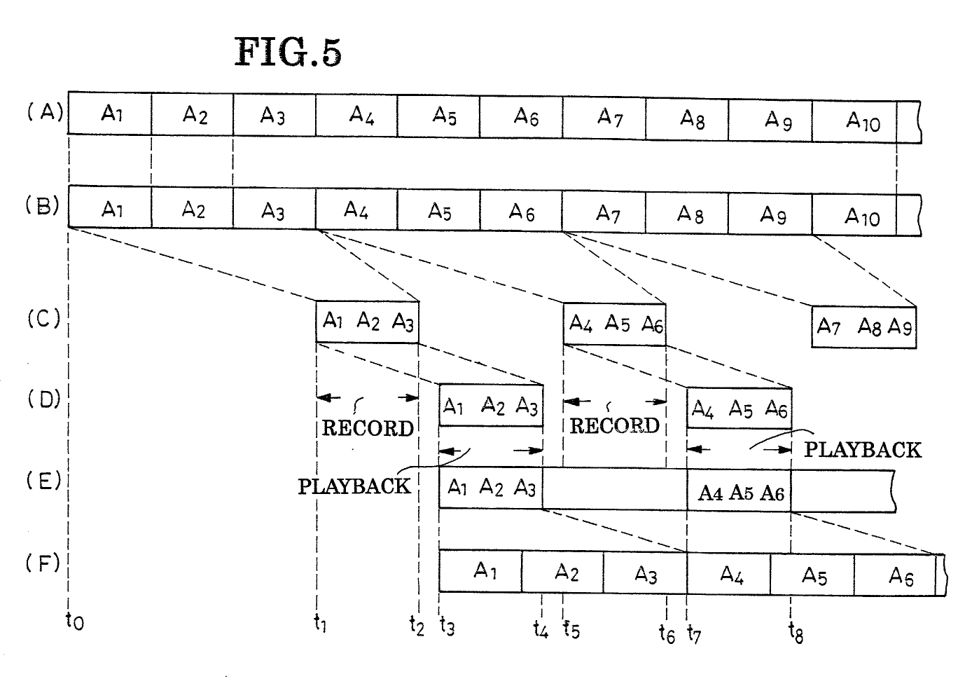

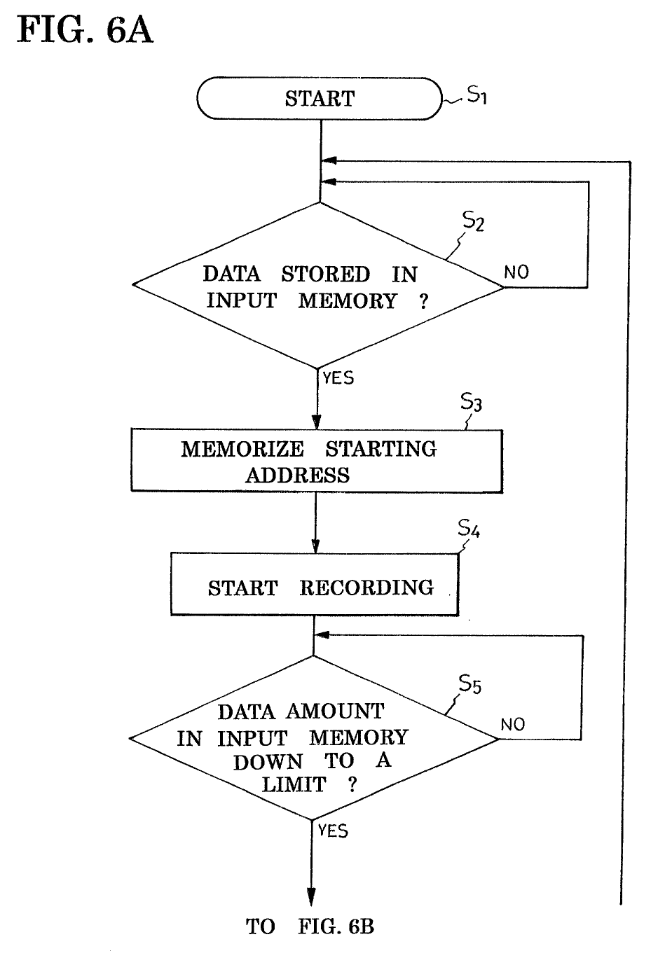

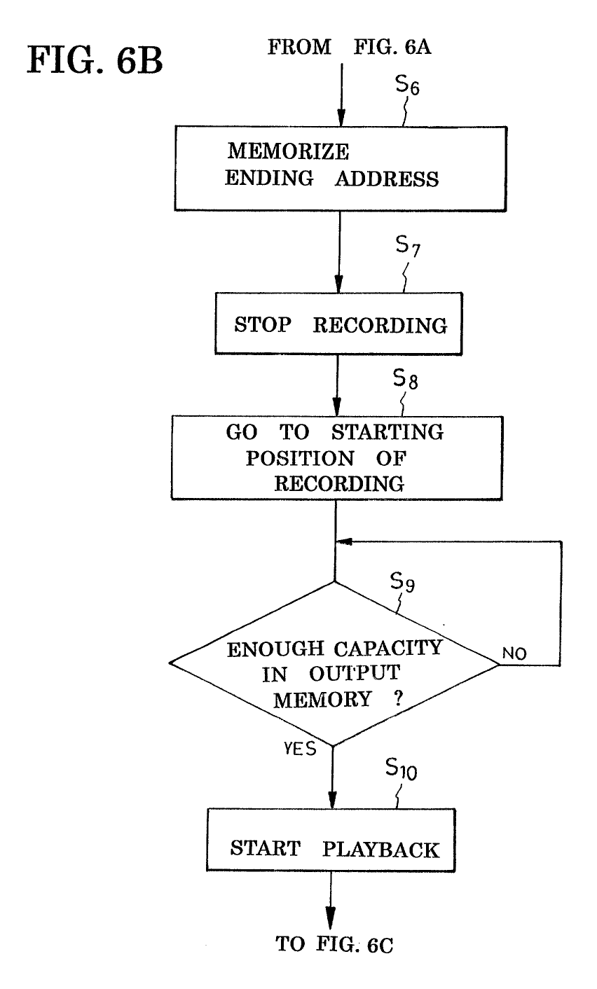

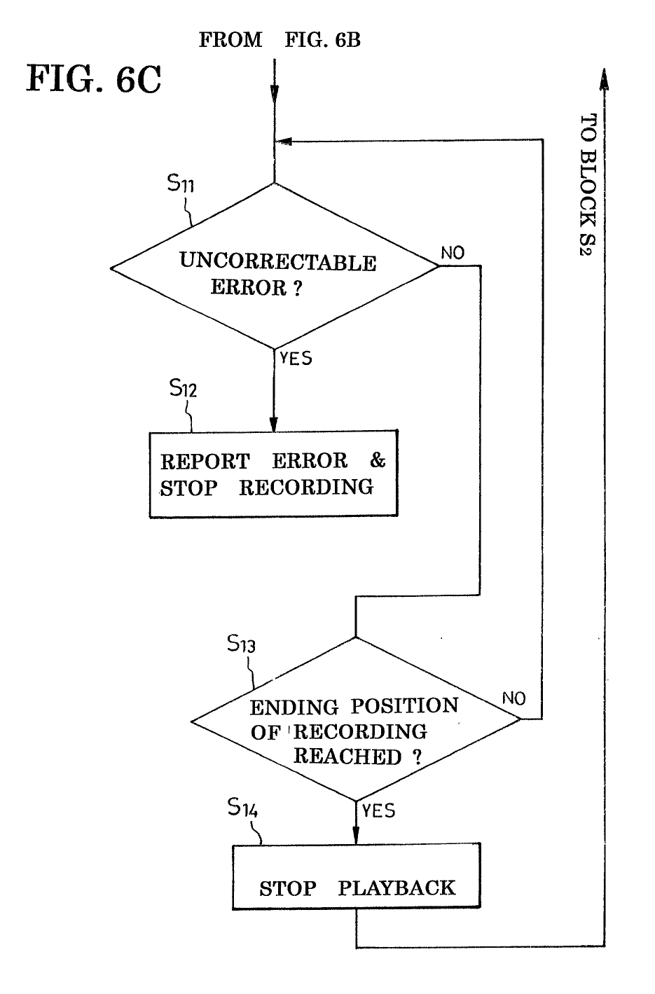

FIG. 5 indicates at (A) the analog audio or like input signal received at the input terminal 14 for recording. The analog input signal is digitized by the ADC 15 into the format depicted at (B) in FIG. 5, which is shown divided into a stream of arbitrary data blocks A,-A,. for convenience of illustration. These data blocks are temporarily stored in successive groups or segments -on the input buffer memory 16. The subsequent recording process will be better understood by referring to the flowchart of FIGS. 6A-6C which indicates the recording program embodying the present invention, to be factory introduced into the controller 13.

The recording program starts at S₁, FIG. 6A, when the input terminal 14 begins to receive the analog signal to be recorded. At the node S₂ it is determined whether a prescribed amount of digital output from the ADC 15 has been stored on the input buffer memory 16. The prescribed amount is shown in FIG. 5 as three data blocks.

The answer yes to the node S₂ directs the routine to the block S₃, which dictates the storage of the track address on the disk 1 where the recording of the first signal segment is started. Besides being stored on the RAM 13c of the controller 13, the starting address is delivered to the write circuit 17 where it is added as subcode to the user data segment being recorded. It is understood that this and all other starting addresses to be used subsequently during recording, are derived from the aforesaid ATIP data.

The recording of the first data segment starts at the next block S₄. As will be noted from (B) and (C) in FIG. 5, the data segment is recorded in time compression mode, such that the data segment is read out from the input memory 16 at a higher rate than that at which it was written thereon. In FIG. 5 the first data segment, consisting of the data blocks A₁-A₃, was written during a time period t₀-t₁ but is read out during a much shorter time period t₁-t₂. The thus time-compressed data segment with the subcode is recorded in the prescribed position on the disk 1.

As has been set forth with reference to FIG. 3, the beam intensity is switched between P₁ and P₂, as from t₁ to t₅ in FIG. 3, during the recording of the first data segment A₁-A₃ from t₁ to t₂ in FIG. 5, as well as of the second data segment A₄-A₆ from t₅ to t₆ in FIG. 5 and all the following data segments. The successive data segments are therefore recorded with concurrent tracking control of the laser beam and address detection.

It is understood that the CD-R 1 is now being driven at a constant linear velocity (CLV) that is from several times to several tens of times, typically four times, as high as the standard CLV common to CDs and CD-Rs. The actual CLV is to be determined in relation to how fast each data segment is read out from the input memory 16. In this manner, even though the transducer assembly 4 has its laser beam modulated according to the successive data segments that are supplied in time compression mode, and hence with intervening time intervals such data segments are recorded on the CD-R with no intervening blanks thereon. The CD-R thus recorded is therefore reproducible on any commercial CD players or CD-ROM drives.

Then comes another node S₅ which asks whether the amount of data currently stored on the input memory 16 is down to a prescribed limit, in order to determine when the write mode now in progress should be terminated. If it is, the track address where the recording of the first data segment ends is stored on the controller RAM 13c at the block S₆, FIG. 6A, and the recording is actually terminated at the next block S₇. Thus has been completed the recording of the first data segment A₁-A₃ from t₁ to t₂ in FIG. 5.

Next comes the step of playing back the first data segment which has been just recorded, for monitoring purposes. The laser beam is therefore positioned at the starting address of the recording of the first data segment on the disk 1 according to the block S₈. It is then determined at the node S₉ if the output buffer memory 19 has enough capacity to store the complete first data segment A₁-A₃ to be recovered from the disk. This step, executed by the output memory control means 33, FIG. 4, of the controller 13, is recommended for the accuracy of reproduction obtainable.

Then the reproduction of the recorded first data segment A₁-A₃ is started at the next block S₁₀. With the disk 1 maintained at the same high CLV as during recording, the first data segment A₁-A₃ is recovered during a t₃-t₄ time interval, as at (D) in FIG. 5, still in a time-compressed state. The time interval t₃-t₄ should not exceed, preferably should be conveniently shorter than, each of the time intervals, as from t₂ to t₅, between the recordings of the successive data segments

The reproduction of the first data segment A₁-A₃ is concurrent with the determination, according to the node S₁₁, FIG. 6C, of whether there exists an uncorrectable error in each EFM frame. If it does, the error is reported to the controller 13, which responds by suspending the recording at the block 52. In cases where this CD-R recorder is being used as a computer peripheral, or has a display of its own, the detected error may be reported to the computer and exhibited on its display, or may be exhibited on the display of the CD-R recorder.

In the absence of any uncorrectable error, it is ascertained at the node S₁₃ whether the final address of the recording of the first data segment A₁-A₃ has been reached. The address in question is that stored on the controller RAM 13c at t₂ in FIG. 5 according to the flowchart block S₆, FIG. 6A. One cycle of recording operation comes to an end at S₁₄, and at t₄ in FIG. 5, when an address that has been read from the disk agrees with the final address on the controller RAM 13c. The next cycle is started at S₂ again.

After being conventionally processed in the read circuit 18, the first data segment A₁-A₃ which has been recovered from the disk from t₃ to t₄ as at (D) in FIG. 5 is then stored on the output buffer memory 19, FIG. 1, as at (E) in FIG. 5. Being still compressed in time, the stored first data segment is then read out therefrom in time extension mode, that is, from t₃ to t₇ as at (F) in FIG. 5, and subsequently reconverted into an analog equivalent by the DAC 21. The first data segment is thus reproduced on the original, normal time scale as a replica of that shown at (A) in FIG. 5.

Upon completion of the recovery of the first data segment A₁-A₃ from the disk 1 at t₄ in FIG. 5, the next data segment A₄-A₅ is recorded during the t₅-t₆ time interval in FIG. 5 through the same procedure as above. The starting address of this second, data segment, to be stored on the controller RAM 13c, FIG. 1, at the block S₃, is the address where the fourth data block A₄ starts to be recorded, or the final address of the preceding data block A₃. As has been stated, no blanks are created between the successive data segments supplied to the transducer assembly 4 in time compression mode.

The second data segment A₄-A₆ thus recorded from t₅ to t₆ on the disk 1, as at (C) in FIG. 5, is immediately reproduced from t₇ to t₈, as at (D) in FIG. 5 and stored on the output buffer memory 19. From this memory 19 the second data segment A₄-A₆ is read out in time extension mode, from t₇ to t₉ as at (F) in FIG. 5, and in immediate succession to the reproduction of the first data segment A₁-A₃.

Thus, even though the input audio or like signal is recorded on, and recovered from, the CD-R 1 in isolated, time-compressed segments according to the invention, the signal emerges from the analog output terminal 21 as a streamlined continuum for realtime monitoring. If unsatisfied with the way his or her source is recorded, the user may immediately suspend the recording and so avoid any further waste of time.

In order to assure continuity of the user data on reproduction, each segment may be composed of, typically, ninety-eight EFM frames or integral multiples thereof. Further the user data may be so divided at zones of longest pit patterns, the frame synchronization patterns provided for frame identification purposes. The synchronization pattern is composed of an 11-bit long high level period, an 11-bit long low level period, and a two-bit long high level period.

Possible Modification

Despite the foregoing detailed disclosure it is not desired that the present invention be limited by the exact showings of the drawings or by the description thereof. The following is a brief list of possible modifications, alterations and adaptations which are all intended in the illustrated embodiments and so believed to fall within the scope of the invention:

1. The digital signal to be recorded could be introduced into the input buffer memory 16 from a source other than the ADC 15.

2. The digital signal recovered from the CD-R could be delivered from the output buffer memory 19 to a digital device other than the DAC 20.

3. The invention could be applied to magneto-optic storages as well.

4. The data track on the disk could be concentric circles instead of a multiturn spiral.

What is claimed is:

1. A method of recording a digital audio or like signal on a rotating data storage disk in a manner enabling realtime monitoring of the recording on the disk, which comprises:
(a) storing on an Input buffer memory a prescribed segment of a digital signal to be recorded;
(b) reading out the signal segment from the Input buffer memory In time compression mode:
(c) recording on a rotating data storage disk the signal segment being read out from the input buffer memory;
(d) repeating the foregoing steps (a), (b) and (c) for recording the successive segments of the digital signal at prescribed time intervals;
(e) recovering each recorded signal segment from the rotating disk during the time interval between the recording of this segment and that of the next segment;
(f) storing on an output buffer memory the signal segment being recovered from the disk;
(g) reading out the signal segment from the output buffer memory in time extension mode;
(h) whereby the successive segments of the digital signal can be read out from the output buffer memory as a streamlined continuum to enable realtime monitoring of the recording being made on the disk.

2. The recording method of claim 1 wherein the data storage disk is maintained in rotation at a constant linear velocity that is predetermined in relation to the extent to which each signal segment is time compressed when being read out from the input buffer memory, whereby the signal segments are recorded on the disk without intervening blanks.

3. The recording method of claim 1 which further comprises:
(a) ascertaining whether or not there is an uncorrectable error in each signal segment being recovered from the rotating disk; and
(b) if there is, visually exhibiting the presence of an uncorrectable error in the recording and/or suspending the recording of the digital signal.

4. The recording method of claim 1 which further comprises:
(a) EFM encoding the successive signal segments being read out from the input buffer memory in time compression mode; and
(b) EFM decoding the successive signal segments being recovered from the disk.

5. An apparatus for recording a digital audio or like signal on a rotating data storage disk in a manner enabling realtime monitoring of the recording on the disk, comprising:
(a) disk drive means for imparting rotation to a data storage disk at a desired speed;
(b) transducer means for recording and playing back a digital signal on and from the rotating data storage disk;
(c) input means;
(d) an input buffer memory connected to the input means for successively storing, at least one at a time, prescribed segments of a digital signal supplied therefrom;
(e) input memory control means connected to the input buffer memory for reading out each signal segment therefrom in time compression mode;
(f) a write circuit connected between the input buffer memory and the transducer means for causing the latter to record on the rotating data storage disk the signal segment being read out from the input buffer memory in time compression mode, so that the successive signal segments are recorded at prescribed time intervals;
(g) mode select means connected to the transducer means for causing the same to read each recorded signal segment on the rotating data storage disk during the time interval between the recording of this segment and that of the next segment;
(h) a read circuit connected to the transducer means for processing each signal segment read out from the disk;
(i) an output buffer memory connected to the read circuit for storing the signal segment being read out from the disk;
(j) output memory control means connected to the output buffer memory for reading out the signal segment from the output buffer memory in time extension mode; and
(k) output means connected to the output buffer memory;
(l) whereby the successive segments of the digital signal, can be read out from the output buffer memory as a streamlined continuum to enable realtime monitoring of the recording being made on the disk.

6. The recording apparatus of claim 5 wherein the input means comprises:
(a) an input for inputting an analog signal to be recorded; and
(b) an analog to digital converter connected to the input for digitizing the analog input signal.

7. The recording apparatus of claim 5 wherein the output means comprises:
(a) a digital to analog converter connected to the output buffer memory for converting into an analog equivalent the digital signal being read out therefrom; and
(b) an output connected to the digital to analog converter.
